(19) United States
(12) Patent Application Publication
(10) Pub. No.: US 2011/0095530 A1
(43) Pub. Date: Apr. 28, 2011

(54) TETHERED AQUATIC DEVICE WITH WATER POWER TURBINE

(75) Inventors: Eric Blumer, Scottsdale, AZ (US); John Thurston, Mesa, AZ (US); Paul Jones, Valencia, CA (US)

(73) Assignee: HONEYWELL INTERNATIONAL INC., Morristown, NJ (US)

(21) Appl. No.: 12/606,039

(22) Filed: Oct. 26, 2009

(51) Int. Cl. F03B 13/00; F03B 15/00

(52) U.S. Cl. 290/43; 290/54; 290/42; 290/53

(57) ABSTRACT

A water power turbine energy conversion device and method of generating electric power that can take advantage of water current speeds is hereinafter disclosed. The water power turbine energy conversion device includes an unmanned tethered aquatic device (TAD) connected to one end of a tether (which may include multiple shorter tethers), the other end being connected to an anchorage point. The TAD comprises a hydrofoil wing-like structure with one or more water power turbines and performs waterborne maneuvers such as cross-current tracking to increase the relative water current speed of up to about four times the true water current speed.

### TECHNICAL FIELD

The present invention relates to sustainable energy sources, and more particularly to a water current driven electric power generating apparatus in the form of a tethered aquatic device having at least one water power turbine for energy conversion.

### BACKGROUND

The energy contained in ocean currents represents a clean, sustainable natural resource for meeting a portion of the world's growing energy needs. The energy contained in the ocean currents can be converted to electricity. There are several areas in the ocean where currents are steady and do not shift location. An example is the Florida Straits current, located a few miles off the southern coast of Florida, near Miami.

Ocean current speeds are on the order of 4 to 10 mph. Although the currents move at low speeds, the density of water is over 800 times the density of air at sea level on a standard day. Power density is directly proportional to fluid density. For example, in a 4 mph current, the power density is the same as that contained in a 44 mph wind at 15,000 feet above sea level.

Commercial utilization of tidal currents and wave energy has steadily increased over the past few decades, but is well shy of providing a significant percentage of global electrical power demand. Known hydro-based turbines have provided massive structures that are configured to store tidal inflow at high tide, and then release it at low tide to provide movement of a turbine. Typically, these tidal current devices include a small pressure head that is utilized to generate power via the turbines. In a wave powered device, wave power produces movement of hinged panels that convert mechanical motion to electricity. In addition, stationary turbines positioned on towers embedded in the ocean floor have also been described.

Modern large hydro-based turbines utilize either extremely heavy step-up gearboxes that have input torques in the millions of pound-feet and drive one or more generators at moderate speed, or do not utilize a gearbox and directly drive an extremely large and heavy generator at low speed. Gearbox reliability is low, and maintenance costs are high. These factors set a minimum value for the cost per kilowatt-hour for hydro-based turbine power systems.

Therefore, it would be desirable to provide an effective hydro-based turbine energy conversion device that is relatively inexpensive to manufacture, deploy, and maintain. It would also be desirable for the device to be able to be utilized in locations that are impractical for ground-based turbines.

### BRIEF SUMMARY

A water current driven electric power generating apparatus and method for generating electric power that can take advantage of water current speed is provided.

In an embodiment, by way of example only, the water current driven electric power generating apparatus includes an aquatic device comprising: a hydrofoil having a wing-like structure and a direction of travel generally perpendicular to a longitudinal length of the hydrofoil; a plurality of flight components to affect cross-current tacking of the hydrofoil about a trajectory; at least one water power turbine coupled to the hydrofoil, wherein the at least one water power turbine comprises: a rotor, at least one rotor blade coupled to the rotor, and an electric power generator coupled to the rotor; and a tether comprising an insulated conductor coupled to the electric power generator, wherein the tether comprises at least a first end and a second end, and wherein the first end of the tether is coupled to the aquatic device and the second end of the tether is coupled to an anchorage point on land or sea.

In another embodiment, by way of example only, the water current driven electric power generating apparatus includes an aquatic device comprising: a hydrofoil having a wing-like structure and a direction of travel generally perpendicular to a longitudinal length of the hydrofoil; a plurality of flight components to affect cross-current tacking of the aquatic device about one of a figure-eight trajectory or a circular trajectory thereby increasing a speed of the aquatic device to greater than a speed of a true water current; at least one water power turbine coupled to a trailing edge of the hydrofoil, relative to the direction of travel, wherein the at least one water power turbine comprises: a rotor, at least one rotor blade coupled to the rotor, and an electric power generator coupled to the rotor, and an active ballast system housed within the hydrofoil and dynamically adjustable to affect center of and total buoyancy of the aquatic device; and a tether comprising an insulated conductor coupled to the electric power generator, wherein the tether comprises at least a first end and a second end, and wherein the first end of the tether is coupled to the aquatic device and the second end of the tether is coupled to an anchorage point on land or sea.

In yet another embodiment, by way of example only, a method for generating electric power with a water current driven electric power generating apparatus includes: coupling an aquatic device to an anchorage point using a tether, wherein the tether comprises an insulated conductor, and wherein the aquatic device comprises: a hydrofoil having a wing-like structure and a direction of travel generally perpendicular to a longitudinal length of the hydrofoil; at least one water power turbine coupled to the hydrofoil, wherein the water power turbine comprises: a rotor, at least one rotor blade, and an electric power generator; and performing waterborne maneuvers including cross-current tacking that enable the aquatic device to consistently travel at speeds greater than a true water current speed, thereby rotating the at least one water power turbine and thus the generator.

Other independent features and advantages of water current driven electric power generating apparatus and method for generating electric power will become apparent from the following detailed description, taken in conjunction with the accompanying drawings which illustrate, by way of example, the principles of the inventive subject matter.

### BRIEF DESCRIPTION OF THE DRAWINGS

The present invention will hereinafter be described in conjunction with the following drawing figure, wherein:

FIG. 1 illustrates a system for energy conversion using a tethered aquatic device (TAD) having at least one water power turbine according to an embodiment;

FIG. 2 illustrates a trajectory of a TAD according to an embodiment;

FIG. 3 illustrates a trajectory of a TAD according to an embodiment;

FIG. 4 illustrates a configuration of a TAD according to an embodiment;

FIG. 5 illustrates a configuration of a TAD according to an embodiment;

FIG. 6 illustrates a configuration of a TAD according to an embodiment;

FIG. 7 illustrates a configuration of a TAD according to an embodiment;

FIG. 8 illustrates a configuration of a TAD according to an embodiment;

FIG. 9 is a rear view of the embodiment of FIG. 8 illustrating the nested diffuser;

FIG. 10 is a schematic of a preferred TAD including an active ballast system according to an embodiment;

FIG. 11 is a graphic depicting the correlation between water speed and power generated using a TAD according to an embodiment;

FIG. 12 is a schematic of a preferred water power turbine centerbody assembly according to an embodiment;

FIG. 13 is a schematic diagram of the preferred two-stage gearbox according to an embodiment; and

FIG. 14 is a schematic of the wound field generator, also known as a wound field synchronous machine, according to an embodiment.

### DETAILED DESCRIPTION OF PREFERRED EMBODIMENTS

Hydro power per unit area increases by the cube of the velocity of the flow. Usable power potentially available in the movement of water, such as in ocean currents, is described by the following equation:

P=½αρAV³, (Equation 1)
where P=power generated in watts, α=an efficiency factor determined by the design of the turbine, ρ=the density of the water (seawater is 1025 kg/m³), A=the swept area of the turbine (in meters²) and V³=the velocity of the flow (in meters per second) cubed (i.e. V×V×V).

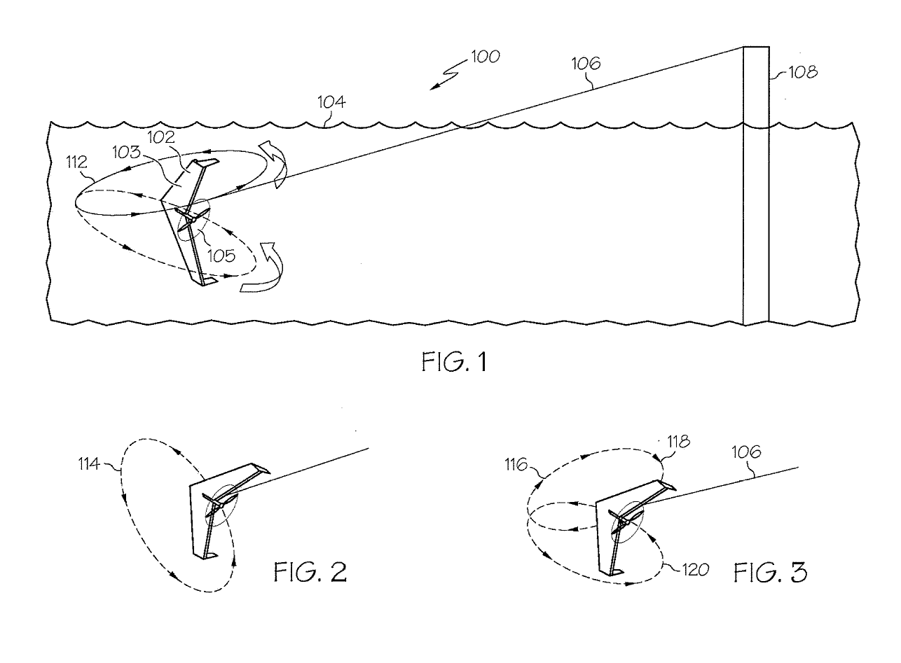

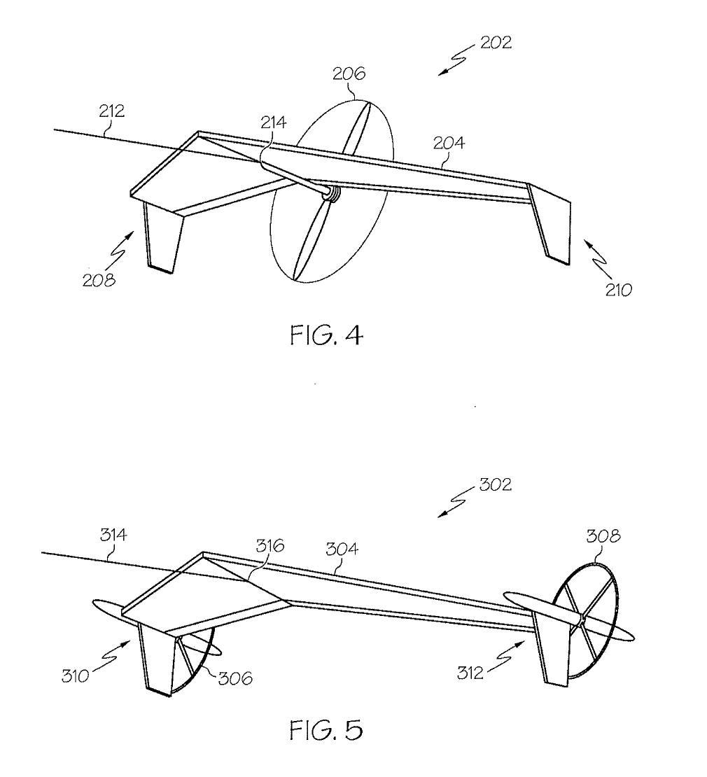

FIG. 1 illustrates a system 100 for hydrokinetic energy conversion using an unmanned and fully autonomous hydrokinetic energy conversion device, and more particularly a tethered aquatic device 102 having at least one water power turbine 105. Various embodiments of the tethered aquatic device (TAD) 102 (with one or more turbines) are illustrated in and described with respect to FIGS. 4-10 The TAD 102 is positioned in a moving water source 104, such as in an ocean current, flowing river, or the like. The TAD 102 is connected by a tether 106 to a mooring or anchorage point, and more particularly a base station 108 (connected to a power distribution system, vehicle, or other device) located on the ground, a sea anchorage point, the sea bed, or other terrestrial object. More than one tether may be used, as may more than one aquatic device, for any particular configuration. In a preferred embodiment, the total tether length is in the range of 100 to 1000 feet or the length necessary to allow the TAD 102 to reach a velocity of approximately 4 times the current. Keeping a portion of the total tether length remaining above the water surface will minimize drag. A tear drop cross-section tether will also minimize drag.

The preferred tether construction is a single composite cable comprised of two insulated aluminum conductors and a high-strength fiber such as Spectra® fiber, a polyethylene fiber available from Honeywell International Inc. High voltage transmission minimizes resistive losses. A small amount of resistive heating helps prevent ice buildup as the cable transits water flows, or the air above the water, that is conducive to icing. The tether 106 is constructed to deliver generated power from a generator (described presently) to the base station 108. Electrical losses from the generation point to the base station 108 should be less than 5%, depending on the length and size of the conductors in the tether 106. The tether 106 is constructed having an area of less than 4 square inches for the aquatic device water power turbine concept described herein. The tether 106 strength must take into account the high device lift created while the TAD 102 is tacking, such as in a circular or figure-eight trajectory (described presently).

The TAD 102 is configured to perform waterborne maneuvers, such as moving or tacking back-and-forth across the current of the water during operation with the tether 106 taught, referred to herein as cross-current tacking. The cross-current tacking provides for movement of the TAD 102 at a speed greater than the speed of the current in which it is positioned, also known as the true current speed. This increase in speed of the TAD 102 greatly enhances the power output (due to the velocity cubed). The limiting value of speed of the cross-current tacking of the TAD 102 is the steady current speed times the overall lift-to-drag ratio of the TAD 102.

Illustrated in FIG. 1 is an exemplary waterborne maneuver or trajectory 112 for the TAD 102. The trajectory 112 illustrated is a figure-eight trajectory, but alternate trajectories, such as that illustrated in FIG. 2 are anticipated. More specifically, illustrated in FIG. 2 is a circular trajectory 114 that could be cross-current tacked as well. When the TAD 102 is cross-current tacked having a circular trajectory 114, a slip mechanism (not shown) may be incorporated, such as at the point where the tether 106 joins a harness assembly (not shown) that is attached to the TAD 102. Referring again to FIG. 1, cross-current tacking of the figure-eight trajectory 112 may be preferable to the simple circular trajectory 114 (FIG. 2), because the tether 106 will not wind up. As illustrated in FIG. 1, the figure-eight trajectory 112 is inclined with respect to the current flow which enables the TAD 102 to reach speeds that are up to four times faster than the true speed of the current flow. The majority of the lift generated by the TAD 102 tensions the tether 106, but a significant portion of lift is a forward component that accelerates the TAD 102 to greater than true water current speeds. The figure-eight trajectory 112 occurs when the TAD 102 reverses the direction of turn during the downward portion of the trajectory pattern. In a preferred embodiment, the TAD 102 has a flight computer that controls surfaces on the TAD 102 to maintain such a trajectory and to keep the tether 106 taut. In one example, each loop of the figure-eight trajectory 112 has an approximate minimum turning radius of around 50 feet.

A figure-eight trajectory may also be flown as two separate circular paths, as best illustrated in FIG. 3, wherein a figure-eight trajectory 116 is comprised of a first generally oval path or first lobe 118 and a second generally oval path or second lobe 120. The TAD 102 would traverse the first lobe 118 of the figure-eight in a clockwise direction a number of times, and then traverse the second lobe 120 of the figure-eight trajectory 116 in a counterclockwise direction the same number of times. This trajectory 116 would wind the tether 106 while traversing the first lobe 118, and unwind the tether 106 as the second lobe 120 is traversed. An optimum trajectory will stay in the fastest moving currents, which are often greater close to the surface.

The TAD 102 includes a high performance hydrofoil 103 with at least one water power turbine 105 coupled thereto. The hydrofoil 103 is generally shaped having a wing-like structure. As the current speed increases, the hydrofoil 103 develops lift and an increase in tether tension, corresponding to an increase in speed of the TAD 102 through the water 104. FIGS. 4-10 illustrate several configurations of the TAD in accordance with presently preferred embodiments of the present invention. The TAD 102 will preferably have a maximum speed of 18 mph, a hydrofoil wingspan of approximately 40 feet, a hydrofoil wing area of approximately 350 square feet, a weight of approximately 20,000 lbs., and a maximum tether tension of approximately 350,000 lbs. Although one hydrofoil 103 is preferred, the TAD 102 may comprise two or more hydrofoils as well. The hydrofoil 103 is generally designed to have greater strength properties than a similar type airborne structure, due to the high lift generated by the hydrofoil 103. Typically, the hydrofoil 103 is fabricated with boat or submarine construction techniques and materials which characteristically possess waterproof properties necessary to achieve operation in the water 104. The hydrofoil 103 is preferably fabricated as a single continuous body that minimizes seams or joints, thus minimizing seals to prevent leakage of water into the hydrofoil structure. At least a single access panel (not shown) may be included that is sealed about a perimeter with a gasket to allow access to the interior of the hydrofoil 103.

FIG. 4 illustrates a first embodiment of a TAD 202, including a hydrofoil 204 and one trailing (relative to the direction of travel) water power turbine 206. The hydrofoil 204 is designed including a first wing tip 208 and a second wing tip 210. The TAD 202 is tethered to an anchorage or mooring point, (base station 108 of FIG. 1) via a tether 212 attached to a tether attachment point 214 located on the hydrofoil 204.

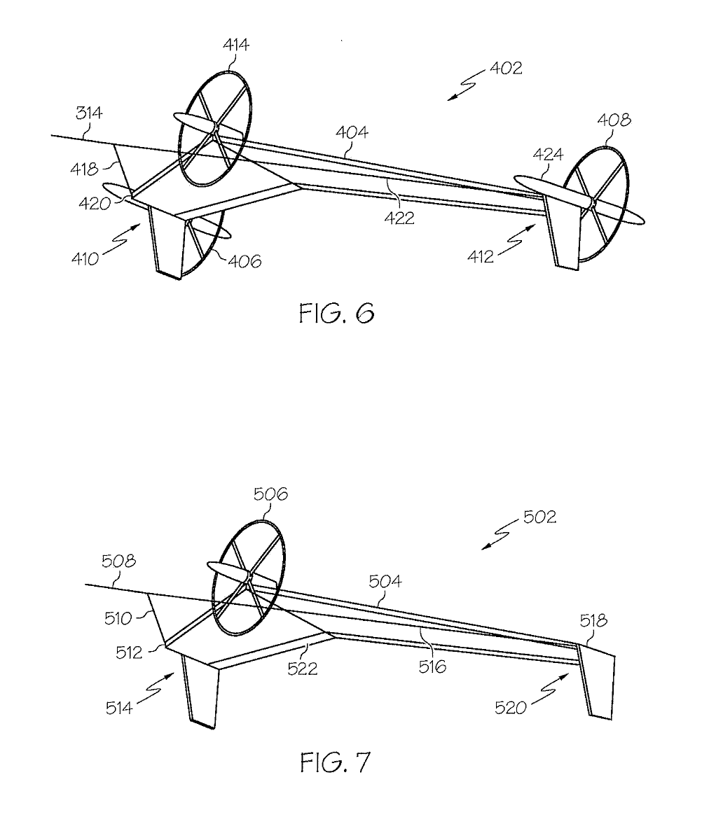

In general, trailing water power turbines are preferred to leading water power turbines for several reasons. First, trailing turbines will have a minimal effect on the flow of water over the top and bottom surfaces of the hydrofoil and a negligible effect on the lift/drag of the TAD. A leading turbine, or turbines, will extract energy from the water that passes through the rotor thus decreasing the velocity of the water flowing over the hydrofoil and reducing the lift. Second, trailing turbines will increase overall stability since the drag created by them is behind the TAD. Drag which leads the TAD, as is the case with a leading turbine, will decrease stability. However, a leading turbine may be used to move the center-of-gravity forward of the TAD and remove the need for a center-of-gravity adjusting ballast. An embodiment including such features is described below with regard to FIG. 6.

FIG. 5 illustrates a second embodiment of a TAD 302 including a hydrofoil 304 having two trailing water power turbines 306 and 308. The hydrofoil 304 is designed including a first wing tip 310 and a second wing tip 312. A first trailing water power turbine 306 is located at the first wing tip 310 and a second trailing water power turbine 308 is located at the second wing tip 312. A tether 314 is attached to a tether attachment point 316 located on the underside of the hydrofoil 304. This configuration has the benefit of not needing winglets to reduce vortices drag. Differential drag between multiple turbines can also a degree of control authority.

FIG. 6 illustrates a third embodiment of a TAD 402 including a hydrofoil 404 having two trailing water power turbines 406 and 408 and a forward facing or leading water power turbine 414. The hydrofoil 404 is designed including a first wing tip 410 and a second wing tip 412. A first trailing water power turbine 406 is located at the first wing tip 410 and a second trailing water power turbine 408 is located at the second wing tip 412. The forward facing water power turbine 414 is located at the center of the hydrofoil 404 to provide a balancing weight to the front of the hydrofoil 404. This balancing weight increases static stability as well as pitch control. A tether 416 splits into two separate tether portions, wherein a first tether portion 418 attaches at a first attachment point 420 located near the first wing tip 410 and a second tether portion 422 attaches at a second attachment point 424 located near the second wing tip 412.

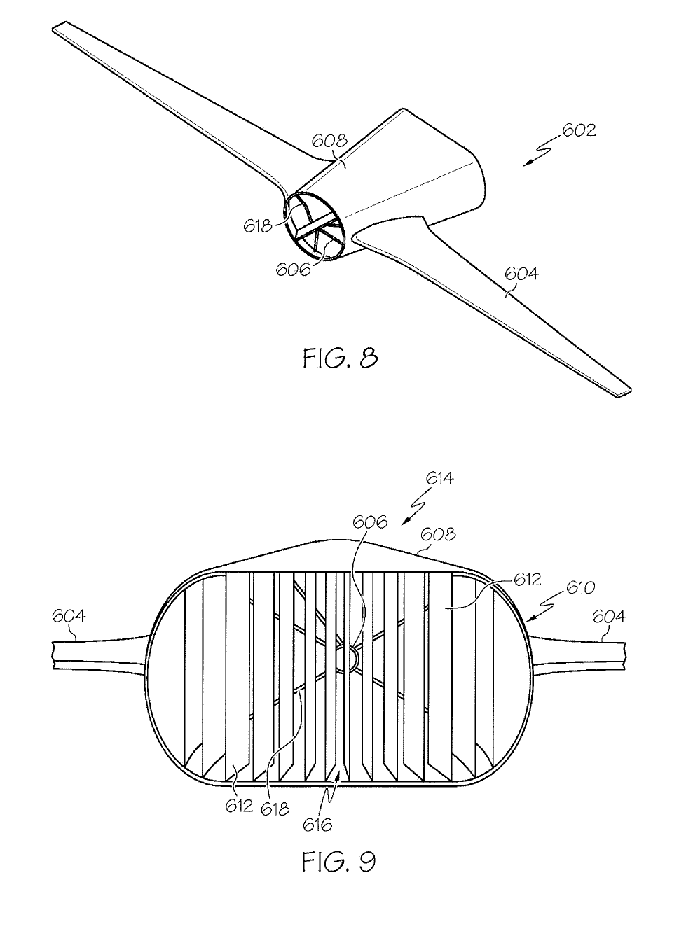

FIG. 7 illustrates a fourth embodiment of a TAD 502 including a hydrofoil 504 having a single, leading water power turbine 506. Similar to the previously described embodiment, a tether 508 is provided that splits into two separate tether portions, wherein a first tether portion 510 attaches at a first attachment point 512 located near a first wing tip 514 and a second tether portion 516 attaches at a second attachment point 518 located near a second wing tip 520.

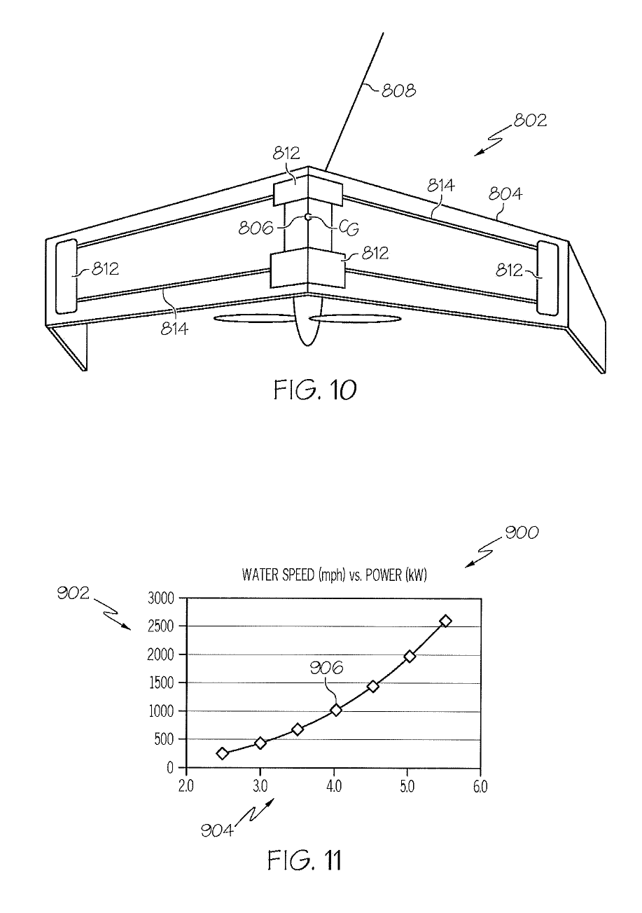

FIG. 8 illustrates a fifth embodiment of a TAD 602 including a hydrofoil 604 having a single, ducted water power turbine 606. A duct 608 shrouds the water power turbine 606 and may contain a nested diffuser as best illustrated in FIG. 9. More specifically, as illustrated in FIG. 9, in an aft view, a nested diffuser 610 includes a plurality of vertical partitions 612 that form a part thereof. The nested diffuser 610 preferably has a generally rectangular cross-section. In this particular embodiment, the height is constant, but the width increases from an inlet 614 to an exit 616. The nested diffuser 610 and ducted water power turbine 606, including a rotor 618, act to increase the speed of the water at a face of the rotor 618 by recovering a significant portion of the pressure drop across the water power turbine 606, and more specifically the rotor 618.

A plurality of flight components that may be associated with the above described embodiments to affect waterborne maneuvers, and more particularly cross-current tacking about a trajectory as previously described, include left and right pairs of elevon control surfaces on the trailing edge of the left and right sides of the hydrofoil, a flight control system, a stability augmentation system, a guidance and navigation system, a transponder, and a position and navigation lighting. Certain other components such as communications or intelligence surveillance equipment may be included in the system as well without departing from the scope of the invention.

Referring again to FIG. 7, the left and right sides of the hydrofoil 504 may include elevon control surfaces, and more particularly inboard and outboard elevons 522 that combine the functions of ailerons and elevators. If both elevons 522 on one side of the hydrofoil 504 move in the opposite direction from the elevons 522 on the other side of the hydrofoil 504, they serve as ailerons and control roll of the TAD 504. If all four elevons 522 move up or down in unison, they serve as elevators and control pitch of the TAD 502. Any combination of pitch and roll may be commanded by independent control of each elevon 522. Yaw may be produced when the elevons 522 on one side of the hydrofoil 504 move in opposite directions. This increases drag on half of the hydrofoil 504, thus inducing yaw. TAD 502 yaw may also be provided by differentially changing the drag produced by the water power turbine 506. Though this embodiment has been shown implemented on TAD 502 of FIG. 7, it is understood that any of the embodiments of the present invention may incorporate similar elevon configurations as well. In an embodiment including trailing water power turbines, slight changes in the pitch of each trailing rotor will cause slight changes in yaw that together with roll is required for turning (banking) the TAD in a coordinated manner. This is especially important when the TAD makes tight, high-G turns during the figure-eight maneuver. Other traditional control authority devices can also be used such as spoilers, leading edge flaps, speed brakes, and rudders.

In the above embodiments, it may desirable to include an active ballast system that dynamically adjusts the center of gravity of the TAD. FIG. 10 illustrates an embodiment of a TAD 802, including a hydrofoil 804, corresponding to the TAD 202 in FIG. 4. The hydrofoil 804 has main tether attachment point (underneath side of hydrofoil 804) near a center of gravity (indicated CG) 806 of the TAD 802. TAD 802 further includes a main tether line 808. During operation, the high lift generated by the hydrofoil 804 requires the tether to be adequately constructed. When there is a single attachment point near the center of gravity 806 of the TAD 802, the hydrofoil 804 must withstand the high bending loads generated by the lift. The TAD 802 should be configured with slightly positive buoyancy so that it rises to the surface in zero currents, but not require extra control authority forces to dive under the surface to perform optimum trajectories. The density of water is 62.4 lbs per cubic foot. The total weight of the TAD 802 should be approximately equivalent to the weight of the water displaced by the volume of the TAD 802 and include any extra weight allowance for the use of materials needed to strengthen the structure of the TAD 802.

To achieve slightly positive buoyancy, as previously alluded to, the TAD 802 may include an active ballast system 810 as illustrated a cut-away top view in FIG. 10. The active ballast system 810 is comprised of a plurality of ballast tanks 812 interconnected by a series of conduits 814 that connect the ballast tanks 812 to the external environment to allow for filling and emptying of the ballast tanks 812. The ballast tanks 812 include at least four internal tanks structures, one each fore and aft of the center of gravity 806 and one each laterally left and right of the center of gravity 806. The active ballast system 810 may further include other associated hardware (not shown) such as a pump and valves to provide adequate control of the flow of water to and from the ballast tanks 812. The term “ballast tank” as used herein may include any container or chamber capable of being filled and emptied of water and capable of dynamically adjusting the center of gravity of the TAD 802 and is not intended to be limited to discrete tanks. Though this embodiment has been shown as corresponding to the TAD 202 of FIG. 4, it is understood that any of the embodiments of the present invention may incorporate a similar active ballast system modifications as well. An active tether attachment point can also be used to as a source of control authority to steer the vehicle.

FIG. 11 is a graph representing the power generated by a hydrokinetic energy conversion device, and more particularly a tethered aquatic device, similar to TAD 202 of FIG. 4. Illustrated in a graph 900 is the amount of power generated (kW) 902 as related to the water speed (mph) 904 during the operation of a TAD, such as TAD 202. More specifically, when TAD 202 is positioned for operation in a water current having a true current speed of approximately 4.0 mph it can deliver approximately 1 megawatt of current through the tether 212 (FIG. 4), graphically represented at 906. In this particular embodiment to achieve this amount of power generation the TAD 202 would include a hydrofoil area of approximately 350 square feet. The trailing turbine, such as turbine 206 of FIG. 4, would have a diameter of approximately 11 feet. During operation, the TAD 202 would be traveling about a trajectory at a speed of at or near 18 mph, having a rotor drag of 56,000 lbs, a hydrofoil drag of approximately 18,000 lbs, a tether drag of approximately 1500 lbs, and a tether load of approximately 350,000 lbs.

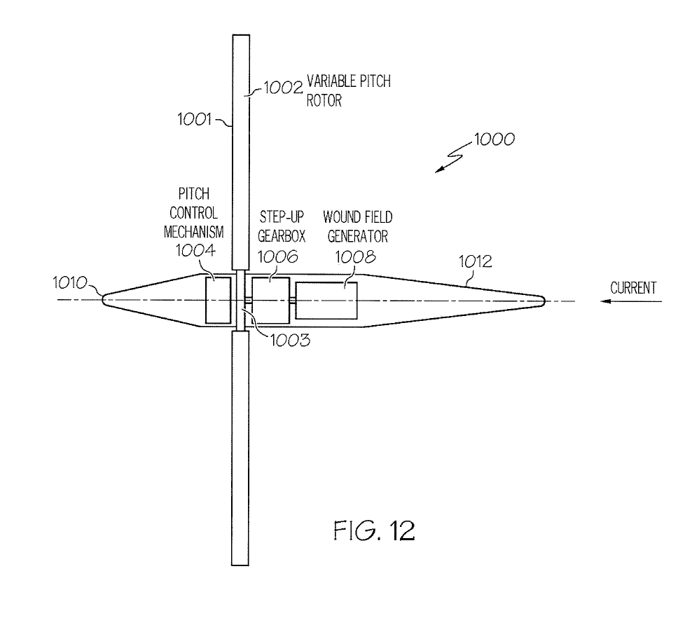

FIG. 12 is a schematic of a preferred water power turbine assembly 1000, and more particularly a water power turbine centerbody assembly, comprising a rotor 1002 including a plurality of rotor blades 1001, a rotor pitch control mechanism 1004, a two-stage gearbox 1006, a high-speed generator 1008, a lubrication/cooling system (not shown), a brake (not shown), and a plurality of composite structural elements including a nose cone 1010, a tail cone 1012, and a surface skin (not shown). Multiple water power turbine centerbody assemblies of the same design may be used on a single autonomous tethered aquatic device, such as on the vehicles illustrated in FIGS. 5 and 6 herein. The water power turbine assembly 1000 assembly is fabricated as a watertight assembly to prevent leakage of water into the assembly. Each of the major components of the turbine centerbody assembly will now be described in further detail.

The rotor 1002 is preferably a two-bladed, high-strength assembly. The root of each rotor blade 1001 is attached to a hub 1003 that contains the rotor pitch control mechanism 1004. The rotor pitch control mechanism 1004 controls the rotor blade pitch from the full feathered position to the full flat pitch position. This device is similar to what is currently used in conventional turboprop-powered aircraft. The rotor pitch control mechanism 1004 is spring-loaded to a feathered position (blades trailing with respect to flow). Oil pressure from the lubrication system provides the source of fluid pressure for pitch control actuation. In the event of loss of oil pressure, the rotor blades 1001 feather, rotation stops, and power-generation ceases. This prevents a catastrophic failure of the rotating components including the gearbox 1006 and the generator 1008.

A brake can be used to lock the rotor in the stowed position and ensure that it does not drift. The two-bladed rotor 1002 will be stowed in a position parallel to a longitudinal axis of the hydrofoil (horizontal) position during deployment to prevent potential damage. The brake is also used to lock down a single rotor in the event the sister rotor becomes disabled. This helps to preclude any differential drag that may adversely affect vehicle stability.

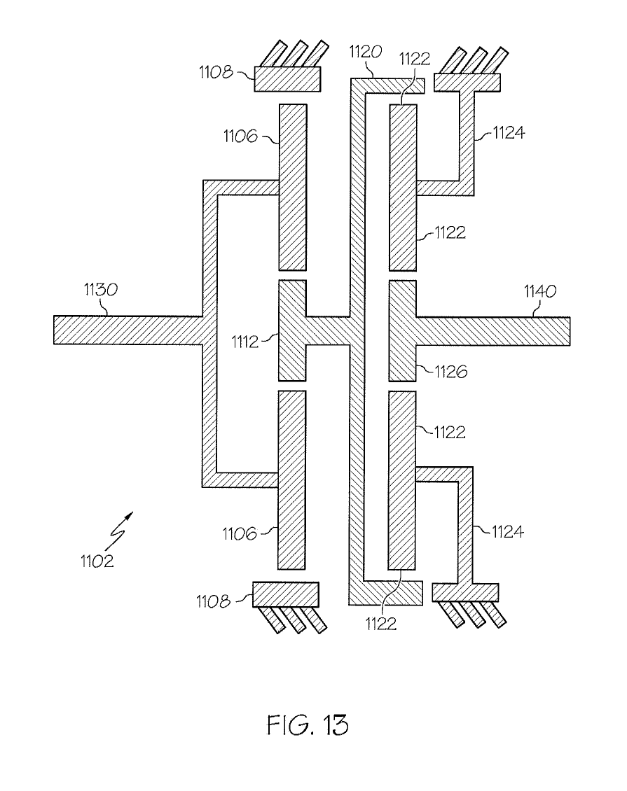

FIG. 13 is a schematic diagram of the preferred two-stage gearbox 1006 of FIG. 1, including a first stage 1102 and a second stage 1104. The first stage is comprised of four planetary gears 1106, a stationary ring gear 1108, a planet carrier 1110, and a sun gear 1112. The second stage is comprised of a ring gear 1120, three planetary gears 1122, a planet gear carrier 1124, and a sun gear 1126. An input shaft 1130 drives the first-stage planet carrier 1110 which supports the first-stage planetary gears 1106. The first-stage planetary gears 1106 are guided by the stationary ring gear 1108 and drive the first-stage sun gear 1112. The first-stage sun gear 1112 drives the second-stage ring gear 1120, which in turn drives three second-stage planetary gears 1122 supported by the second stage planet carrier 1124. The second-stage planetary gears 1122 drive the second-stage sun gear 1126 that drives an output shaft 1140. The purpose of the gearbox 1006 is to step-up the speed of the water power turbine rotor in order to drive the generator at a higher speed. At the rated power of 1 megawatt, the rotor speed is 900 rpm. The two-stage gearbox 1006 increases this input speed to 15,000 rpm (16.7-to-1). A larger, slower generator without a speed increasing gearbox may also be utilized.

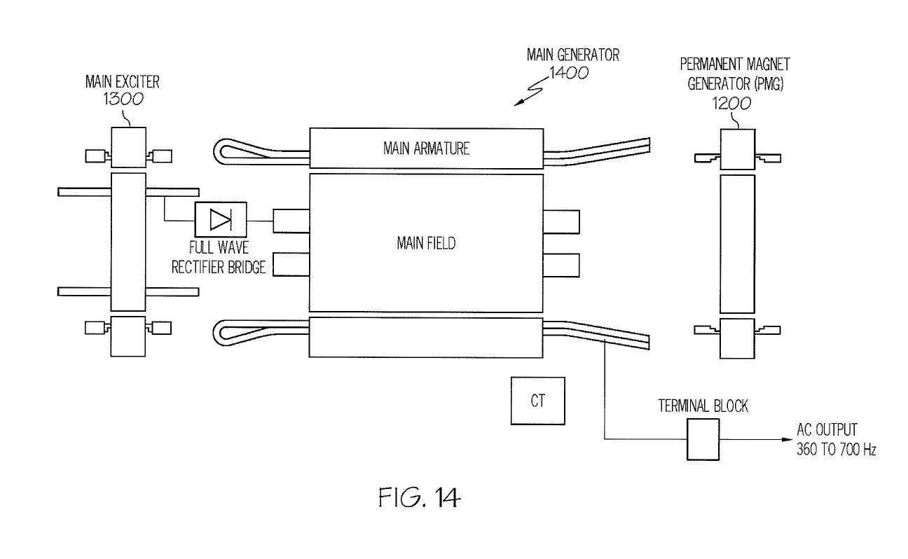

FIG. 14 is a schematic of the wound field generator 1008 of FIG. 12, also known as a wound field synchronous machine. The generator is designed to operate at high speed. The advantage of high speed operation is that the generator can produce high electrical power output in a compact, light-weight package. The generator 1008 is comprised of three separate generators on a single shaft. A first stage 1200 is a small permanent magnet generator that supplies excitation power via a generator control unit (GCU) to a second stage 1300. The second stage 1300 is an exciter generator that provides main field excitation to a third stage 1400. The third stage 1400 is the main generator that provides the main power output. Advantages of this generator design include high power density, self excitation, easy voltage regulation, good transient performance, good fault protection via the GCU, and high reliability due to the absence of brushes or other contacting parts except for the bearings. Two or more generators can be paralleled on the tether conductors without power electronics with a simple diode bridge to generate high voltage DC. The generator can also be used as a motor if motor commutation electronics are included. Other high-speed generator types including permanent magnet and induction may be used instead of the wound field generator.

An included lubrication and cooling system is preferred. The lubrication system provides oil lubrication to the gearbox 1006 and the generator 1008 internal bearings and gears. The lubrication and cooling system preferably includes an air-to-liquid heat exchanger that maintains oil temperature within normal operating limits. The lubrication system may also provide oil pressure to the rotor pitch control mechanism 1004.

While the inventive subject matter has been described with reference to a preferred embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

We claim:

1. A water current driven electric power generating apparatus comprising:
an aquatic device comprising:
a hydrofoil having a wing-like structure and a direction of travel generally perpendicular to a longitudinal length of the hydrofoil;
a plurality of flight components to affect cross-current tacking of the hydrofoil about a trajectory;
at least one water power turbine coupled to the hydrofoil, wherein the at least one water power turbine comprises:
a rotor,
at least one rotor blade coupled to the rotor, and
an electric power generator coupled to the rotor; and
a tether comprising an insulated conductor coupled to the electric power generator, wherein the tether comprises at least a first end and a second end, and wherein the first end of the tether is coupled to the aquatic device and the second end of the tether is coupled to an anchorage point on land or sea.

2. The apparatus of claim 1, wherein the water power turbine is coupled to a trailing edge of the hydrofoil, relative to the direction of travel.

3. The apparatus of claim 1, wherein the aquatic device further comprises a water power turbine coupled to a leading edge of the hydrofoil, relative to the direction of travel.

4. The apparatus of claim 1, wherein the hydrofoil further includes an active ballast system.

5. The apparatus of claim 4, wherein the active ballast system includes at least four internal tank structures, one each fore and aft of a center of gravity of the aquatic device and one each laterally left and right of the center of gravity of the aquatic device.

6. The apparatus of claim 1, wherein the hydrofoil further includes an active tether attachment point system.

7. The apparatus of claim 1, wherein the plurality of flight components include an elevon control surface on the hydrofoil.

8. The apparatus of claim 1, wherein the at least one water power turbine further comprises a rotor pitch control mechanism adapted to adjust pitch of the at least one rotor blade.

9. A water current driven electric power generating apparatus comprising:
an aquatic device comprising:
a hydrofoil having a wing-like structure and a direction of travel generally perpendicular to a longitudinal length of the hydrofoil;
a plurality of flight components to affect cross-current tacking of the aquatic device about one of a figure-eight trajectory or a circular trajectory thereby increasing a speed of the aquatic device to greater than a speed of a true water current;
at least one water power turbine coupled to a trailing edge of the hydrofoil, relative to the direction of travel, wherein the at least one water power turbine comprises:
a rotor,
at least one rotor blade coupled to the rotor, and
an electric power generator coupled to the rotor, and
an active ballast system housed within the hydrofoil and dynamically adjustable to affect center of and total buoyancy of the aquatic device; and
a tether comprising an insulated conductor coupled to the electric power generator, wherein the tether comprises at least a first end and a second end, and wherein the first end of the tether is coupled to the aquatic device and the second end of the tether is coupled to an anchorage point on land or sea.

10. The apparatus of claim 9, wherein the aquatic device further comprises a water power turbine coupled to a leading edge of the hydrofoil, relative to the direction of travel.

11. The apparatus of claim 9, wherein the active ballast system includes at least four internal tank structures, one each fore and aft of a center of gravity of the aquatic device and one each laterally left and right of the center of gravity of the aquatic device.

12. The apparatus of claim 9, wherein the plurality of flight components include at least one of an elevon control surface on the hydrofoil, a flight control system, a stability augmentation system, a guidance and navigation system, a transponder and a position and navigation lighting.

13. The apparatus of claim 9, wherein the at least one water power turbine further comprises a rotor pitch control mechanism adapted to adjust pitch of the at least one rotor blade.

14. The apparatus of claim 9, wherein the at least one water power turbine further comprises a speed increasing gearbox coupled to the rotor and the electric power generator.

15. The apparatus of claim 9, wherein the rotor is ducted and includes a nested diffuser.

16. A method for generating electric power with a water current driven electric power generating apparatus, the method comprising:
coupling an aquatic device to an anchorage point using a tether,
wherein the tether comprises an insulated conductor, and
wherein the aquatic device comprises:
a hydrofoil having a wing-like structure and a direction of travel generally perpendicular to a longitudinal length of the hydrofoil;
at least one water power turbine coupled to the hydrofoil, wherein the water power turbine comprises:
a rotor, at least one rotor blade, and an electric power generator; and
performing waterborne maneuvers including cross-current tacking that enable the aquatic device to consistently travel at speeds greater than a true water current speed, thereby rotating the at least one water power turbine and thus the generator.

17. The method of claim 16, wherein the water power turbine is coupled to a trailing edge of the hydrofoil, relative to the direction of travel.

18. The method of claim 16, wherein the aquatic device further comprises a water power turbine coupled to a leading edge of the hydrofoil, relative to the direction of travel.

19. The method of claim 16, wherein performing the waterborne maneuvers comprises traveling in one of a circular path and a figure-eight path.

20. The method of claim 19, wherein the figure-eight path comprises a first generally circular path and a second generally circular path, and traveling in the figure-eight path comprises traversing the first generally circular path of the figure-eight path a plurality of times then traversing the second generally circular path of the figure-eight path a plurality of times in an opposite circular direction relative to the first generally circular path.
